(19) United States
(12) Patent Application Publication
(10) Pub. No.: US 2013/0159125 A1
(43) Pub. Date: Jun. 20, 2013

(54) System and Process for Managing Sale of One or More Items

(71) Applicants: Jonathon Flavel, Brunswick (AU); Ben Flavel, Brunswick (AU); Jay Beavis, Northcote (AU)

(72) Inventors: Jonathon Flavel, Brunswick (AU); Ben Flavel, Brunswick (AU); Jay Beavis, Northcote (AU)

(73) Assignee: EQUEUE PTY LTD, Brunswick, Victoria (AU)

(21) Appl. No.: 13/582,549

(22) PCT Filed: Oct. 15, 2010
(86) PCT No.: PCT/AU10/01370

§ 371 Date: Nov. 8, 2012

(30) Foreign Application Priority Data
Mar. 2, 2010 (AU) 2010900868

(51) Int. Cl. G06Q 10/02

(52) U.S. Cl. CPC G06Q 10/02; G06Q 30/0601
USPC 705/26.1

(57) ABSTRACT

A system for managing sale of one or more items, said system for performing the steps of generating predetermined activities for potential purchasers of one or more of said items before said items are available for sale; ranking the potential purchasers in accordance with results of said predetermined activities; and allocating each potential purchaser of said purchasers a time period within which he or she is permitted to purchase one or more of said items, after the items are made available for sale, in accordance with his or her ranking.

### TECHNICAL FIELD OF THE INVENTION

The present invention relates to a system, process and computer program for managing sale of one or more items.

### BACKGROUND OF THE INVENTION

There has previously been difficulties with the way in which tickets for events have been sold. For example, crazed fans have previously queued up for days outside ticket outlets in the hope that they will be able to purchase tickets for their event of choice. It may not always be convenient to queue up for tickets for extended periods.

On-line ticket management systems may provide a useful alternative to physically queuing up for tickets. Such systems permit a user to purchase a ticket for an event over the Internet by logging on to a website, and purchasing a ticket to an event of choice. However, when tickets for an event are made available for sale, a large volume of people attempt to access the system to purchase tickets, On-line ticketing systems may have previously struggled to cope when a large number people wish to access the system at the same time. The flood of demands incident on the system often proves to be too much, slowing the system's ability to service requests, disconnecting patrons and potentially even crashing the system. In such circumstances, the system may select customers at random to purchase items without any controls. These difficulties have previously lead to patrons not being able to purchase tickets for events for extended periods after the tickets have gone on sale.

Even die hard fans, fiercely committed to purchasing good tickets to an event, can find themselves disappointed after discovering that they can only, at best, purchase sub-standard tickets for an event despite their best efforts to do so. Further, such die hard fans may have to cope with the disappointment of discovering that lesser fans were able to purchase better seats with minimal effort.

On-line ticketing systems have previously done little to counteract people purchasing large volumes of tickets and then selling them at a later date at inflated prices.

It may be generally desirable to overcome or ameliorate one or more of the above mentioned difficulties, or to at least provide a useful alternative.

### SUMMARY OF THE INVENTION

In accordance with one aspect of the invention, there is provided a system for managing sale of one or more items, said system for performing the steps of:
(a) generating predetermined activities for potential purchasers of one or more of said items before said items are available for sale;
(b) ranking the potential purchasers in accordance with results of said predetermined activities; and
(c) allocating each potential purchaser of said purchasers a time period within which he or she is permitted to purchase one or more of said items, after the items are made available for sale, in accordance with his or her ranking.

Preferably, the step of ranking the potential purchasers is effected in accordance with frequency of said predetermined activities.

Preferably, the step of ranking the potential purchasers is effected in accordance with the accuracy of said predetermined activities.

In accordance with another aspect of the invention, there is provided a system for managing sale of one or more items, said system for performing the steps of:
(a) generating data representing a plurality of potential purchasers of said one or more items; and
(b) allocating each potential purchaser of said purchasers a time period within which he or she is permitted to purchase said items after the items are made available for sale.

In accordance with another aspect of the invention, there is provided a system for managing sale of one or more items, said system for performing the steps of:
(a) generating predetermined activities for potential purchasers of one or more of said items before said items are available for sale; and
(b) ranking the potential purchasers in accordance with results of said predetermined activities.

In accordance with another aspect of the invention, there is provided a process for managing sale of one or more items, including the steps of:
(a) generating predetermined activities for potential purchasers of one or more of said items before said items are available for sale;
(b) ranking the potential purchasers in accordance with results of said predetermined activities; and
(c) allocating each potential purchaser of said purchasers a time period within which he or she is permitted to purchase one or more of said items, after the items are made available for sale, in accordance with his or her ranking.

In accordance with another aspect of the invention, there is provided a process for managing sale of one or more items, including the steps of:
(a) generating data representing a plurality of potential purchasers of said one or more items; and
(b) allocating each potential purchaser of said purchasers a time period within which he or she is permitted to purchase said items after the items are made available for sale.

In accordance with another aspect of the invention, there is provided a process for managing sale of one or more items, including the steps of:
(a) generating predetermined activities for potential purchasers of one or more of said items before said items are available for sale; and
(b) ranking the potential purchasers in accordance with results of said predetermined activities.

In accordance with another aspect of the invention, there is provided a computer program for managing sale of one or more items, said program for performing the steps of:
(a) generating predetermined activities for potential purchasers of one or more of said items before said items are available for sale;
(b) ranking the potential purchasers in accordance with results of said predetermined activities; and
(c) allocating each potential purchaser of said purchasers a time period within which he or she is permitted to purchase one or more of said items, after the items are made available for sale, in accordance with his or her ranking.

In accordance with another aspect of the invention, there is provided a computer program for managing sale of one or more items, said program for performing the steps of:
(a) generating data representing a plurality of potential purchasers of said one or more items; and
(b) allocating each potential purchaser of said purchasers a time period within which he or she is permitted to purchase said items after the items are made available for sale.

In accordance with another aspect of the invention, there is provided a computer program for managing sale of one or more items, said program for performing the steps of:
(a) generating predetermined activities for potential purchasers of one or more of said items before said items are available for sale; and
(b) ranking the potential purchasers in accordance with results of said predetermined activities.

In accordance with another aspect of the invention, there is provided a computer readable data storage medium including, stored thereon, the above described computer program.

### BRIEF DESCRIPTION OF THE DRAWINGS

Preferred embodiments of the present invention are hereafter described, by way of non-limiting example only, with reference to the accompanying drawing in which:

FIG. 1 is a diagrammatic illustration of a data repository system connected to a network;

FIG. 2 is a diagrammatic illustration of the system shown in FIG. 1;

FIG. 3 is a flow diagram showing steps performed by the system for setting up a new event;

FIG. 4 is a flow diagram showing the steps performed by the system to register a potential purchaser of a good or service;

FIG. 5 is a flow diagram showing the steps performed by the system to effect a queue up process;

FIG. 6 is a flow diagram showing the steps performed by the system after the queue up window has closed; and

FIG. 7 is a flow chart showing the steps performed by the system to purchase an item for a purchaser.

### DETAILED DESCRIPTION OF PREFERRED EMBODIMENTS OF THE INVENTION

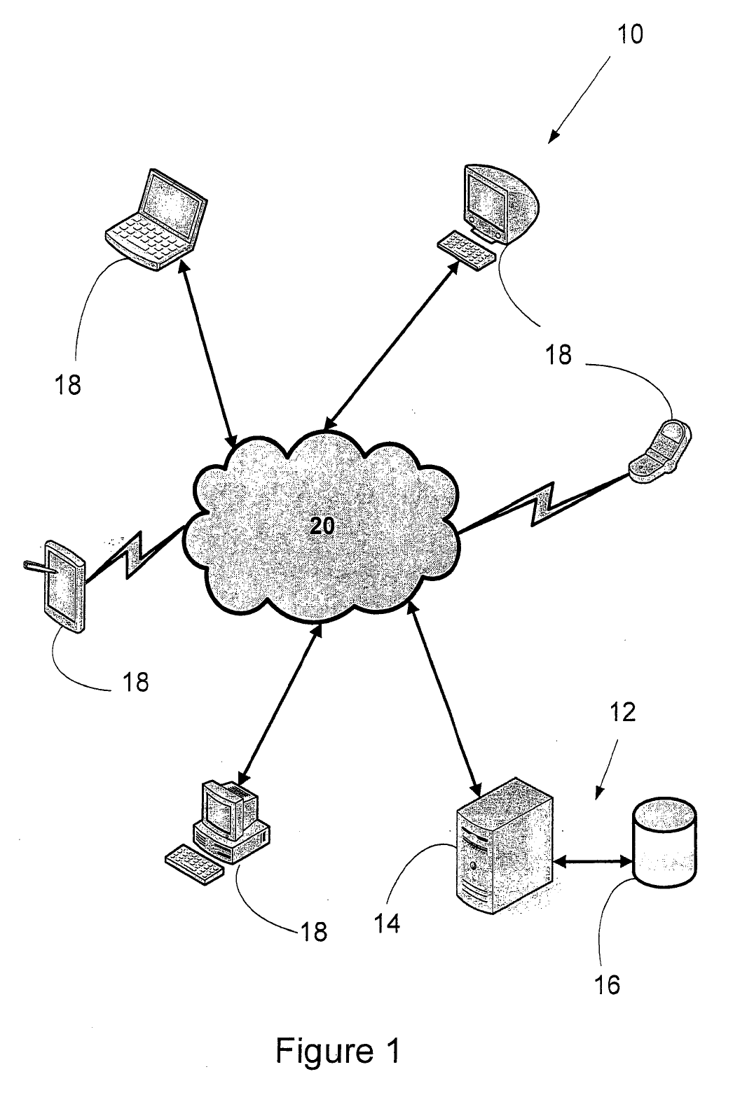

The system 10 shown in FIG. 1 is used to manage the sale of one or more items, such as tickets for a rock concert. The system 10 can be used to manage the sale of one or more items of any particular good or service for an event. For example, the system 10 can be used to manage the sale of items for an on-line store for a blockbuster sale. Alternatively, the system 10 can be used to manage the sale of services provided by a company when the company first opens the doors for trading. However, for convenience, preferred examples of the system 10 are hereafter described, by way of non-limiting example only, with reference to an event being the sale of tickets for a rock concert.

The system 10 is used to manage the sale of tickets for a concert in a way that, advantageously, facilitates a fair distribution of tickets for the concert. The system 10 is used to:

1. Set-up new event;

2. Register a user;

3. Queue-up; and

4. Purchase an item.

The system 10 is used to set-up an event for a person or organisation desirous of selling tickets to an up coming rock concert. People wishing to attend the concert can register their details with the system 10. Each person registered for an event can effectively queue up to purchase a ticket before the tickets are available for sale by completing a number of predetermined activities. For example, system 10 may ask the potential purchaser to re-register his or her details with the system 10. Alternatively, the predetermined activity may be a game to be completed by the potential purchaser. After the queuing up process has closed, the system 10 ranks the registered users in accordance with results of the predetermined activities. That is, the users are ranked in accordance with the accuracy of each activity they have participated in and the frequency of the activities.

The system 10 allocates each potential purchaser a time period within which he or she is permitted to purchase tickets after they have been made available for sale. The system 10 allocates the predetermined time periods in accordance with the corresponding rankings.

A registered user can purchase a ticket for the concert during his or her allotted time period. During this period a restricted number of people are permitted to buy tickets to the concert. The purchaser may purchase one or more tickets after his or her time period has expired.

The Computer System

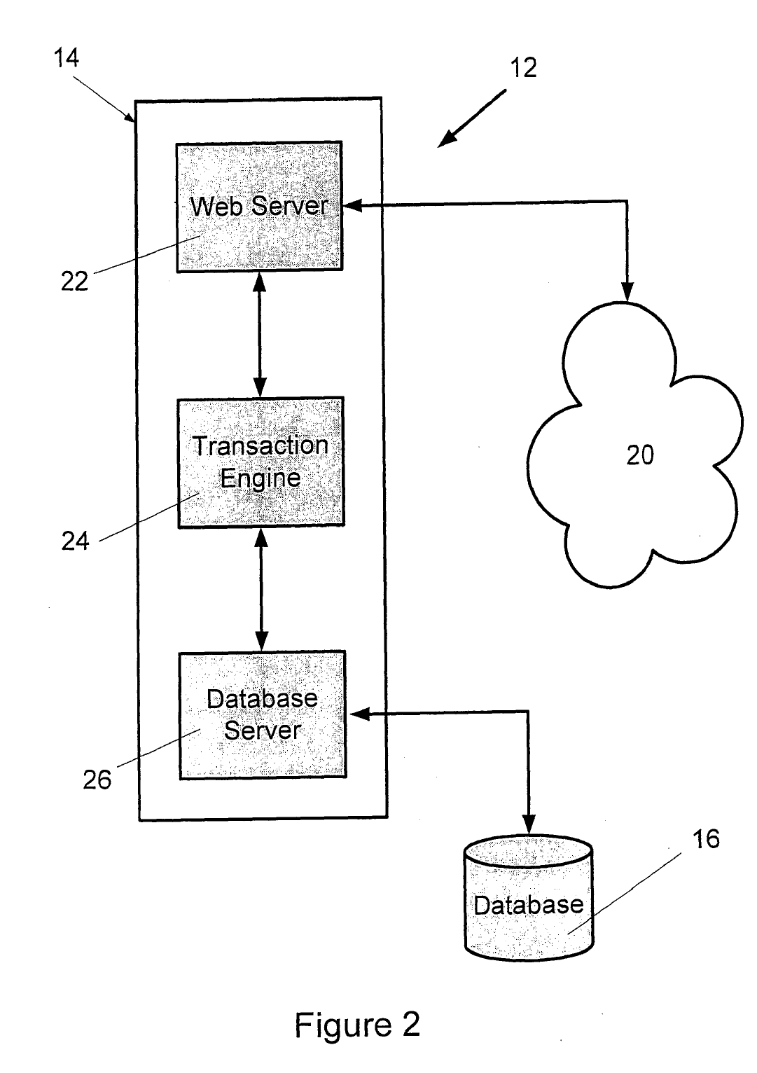

The management system 10 is provided by the computer system 12 shown in FIG. 2. The computer system 12 includes a server 14 in communication with a database 16. The computer system 12 is able to communicate with equipment 18 of members, or users, of the system 12 over a communications network 20 using standard communication protocols. The equipment 18 of the members can be a variety of communications devices 18 such as personal computers; interactive televisions; hand held computers etc. The communications network 20 may include the Internet, telecommunications networks and/or local area networks.

The components of the computer system 12 can be configured in a variety of ways. The components can be implemented entirely by software to be executed on standard computer server hardware, which may comprise one hardware unit or different computer hardware units distributed over various locations, some of which may require the communications network 20 for communication. A number of the components or parts thereof may also be implemented by application specific integrated circuits (ASICs). It will be apparent from the description of the system 12, and its operation below, that the most practical implementation of the components of the computer system 12 is a software implementation. Alternative methods of providing system displays and information can also be used, for example WML pages for mobile telephones, and interactive voice response (IVR) systems for connection to standard fixed telephones or voice over IP terminals.

The server 14 of the computer system 12 includes a web server 22, a transaction engine 24 and a database server 26 arranged in the manner shown in FIG. 2. The web server 22 is software stored on the server 14 that allows the computer system 12 to serve static and dynamic web pages of the web application. The web server 22 allows members of the system 10 to access web pages created and stored on the computer system 12 via their respective communications devices 18. The web pages published by the web server 22 are dynamic and are populated by data provided by the transaction engine 24 of the computer system 12.

The transaction engine 24 is software that processes data received by the web server 22 from users of the system 10 via their terminals 18 and is able to retrieve and store data on the database 16 via the database server 26. The transaction engine 24 communicates with the web server 22 and database server 26 to execute data transactions for the system 12 and thereby provides dynamic content for the web pages provided by the web server 22, as described below.

The database server 26 is software stored on the server 14. The database server 26 reads, writes, maintains and secures data on the database 16. The database server 26 maintains data in the database 16 for all members of the system 10. The database 16 is maintained preferably on hard disk storage of the server 14 of the computer system 12.

As above-mentioned, the system is used to:

1. Set-up new event;

2. Register a user;

3. Queue-up; and

4. Purchase an item.

A detailed description of the operation of the system 12 to effect these functions is set out below.

1. Set-Up New Event

A system administrator can use his or her person al computer 18 to access the system 12 home page (not shown) via the Internet 20 and setup a new event for a customer. In this description, an administrator is a user who has the ability to set-up or create a new event with the program. This ability is often reserved for the owner of the program or the server executing the program. A customer is a person or organisation that is desirous of running an event such as the sale of tickets for a concert, or the registration of people to a seminar.

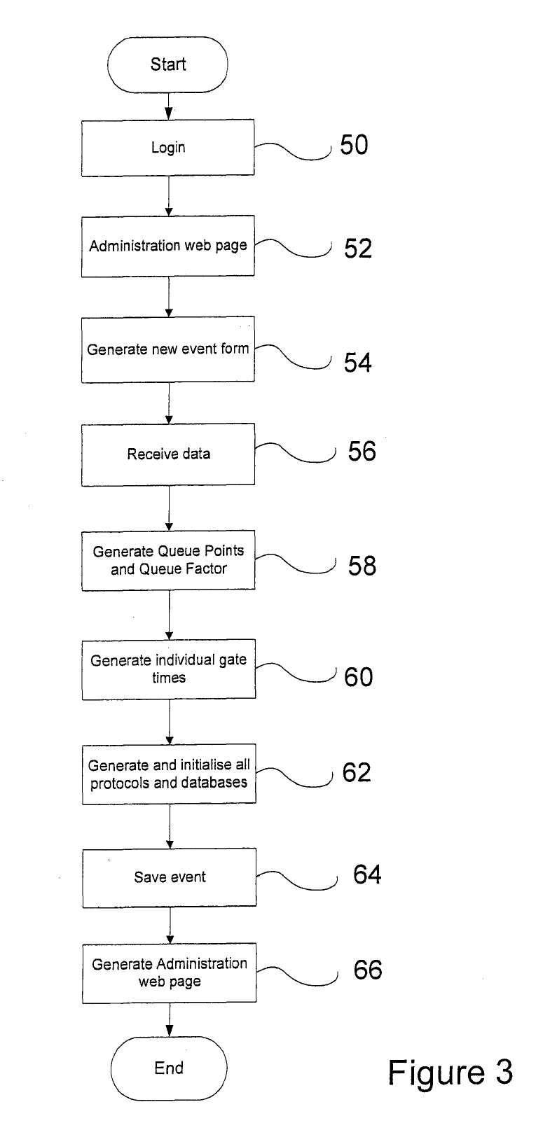

The system 12 performs the steps shown in FIG. 3 to set-up a new event. The home page includes a “Login” function button (not shown). On receipt of the correct administrator's login and password, at step 50, the system 12 generates, at step 52, a display showing the administrator's web page (not shown). The web page includes, amongst other things, a “Create New Event” function button that, when executed, generates, at step 54, a form including the following data boxes:
a. User Prioritisation Rules:
   i. Queue End Date;
   ii. Queue Length; and
   iii. Queue Frequency,
b. Access Control Rules:
   i. Event Title;
   ii. Event Open Date;
   iii. Event Close Date;
   iv. Queue Positions;
   v. Queue Gate Width; and
   vi. Queue Gate Length.

The system 12 receives, at step 56, data from the administrator for these data boxes to structure the event for the customer. A description of the user prioritisation rules and the access control rules is set out below.

a. User Prioritisation Rules

The Queue End Date is the date that the customer decides will be the final date on which the users can complete the queuing up process for tickets for the concert. The Queue Length defines how many times a user can access and complete activities. The Queue frequency defines how often a user can complete activities and is stored in hours. On receipt of this information, the system 10 generates, at step 58:
i. Queue Points based on the defined Queue frequency; and
ii. Queue Factor base on the Queue Points.

The Queue Factor is used to prioritise users after the Queue End Date.

b. Access Control Rules

The Event Open Date defines when the User Prioritisation process has closed and when the Access Control process has commenced. The event closed date defines when the Access Control is lifted and the greater public is granted the opportunity to purchase tickets to the concert.

The Queue Positions defines the quantity of users guaranteed the opportunity to purchase participate in the queuing process using the system 10. The Queue Gate Width is the number of positions that can be allocated to each gate. Similarly, the Queue Gate Length is the amount of time that each gate is open, before the next successive gate also opens. On receipt of this information, the system 10 generates, at step 60, the, individual gate times for the event.

On successful entry of the above data, the system 12 generates and initialises, at step 62, all protocols and databases necessary for the event. The system 12 saves, at step 64, the relevant information in the database 16 as an event and generates, at step 66, the administrator's web page for display on the administrator's personal computer 18.

The database administrator can select an event from a drop down menu to edit the data for any event saved on the database 16.

2. Register a User

A person can use his or her personal computer 18 to access the system's home web page (not shown) via the Internet 20. The home page generated by the system 12 includes a “Register” function button.

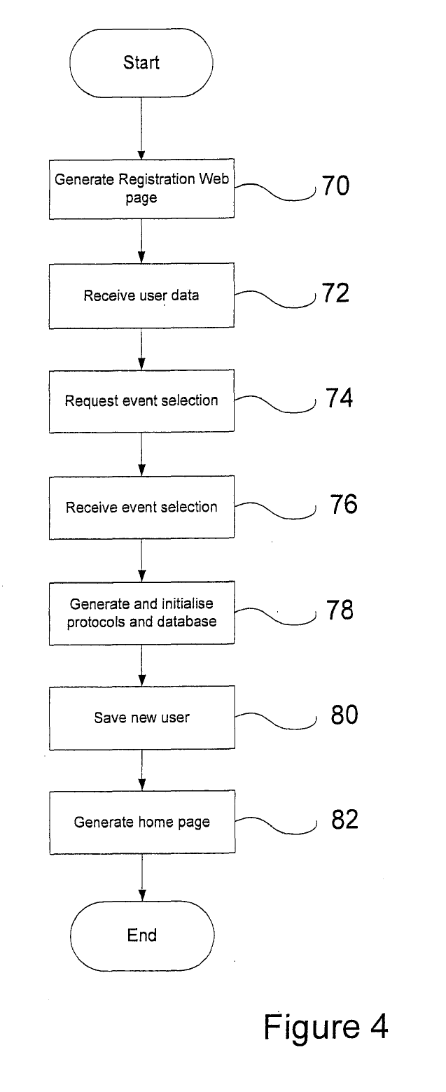

The system 12 performs the steps shown in FIG. 4 to register new users for an event. A person can become a member of the system 10 by executing the “Register” function button (not shown) on the system's home page. The system 12 generates, at step 70, the Registration web page (not shown) on detection of execution of the “Register” function button. The Registration web page includes the following data boxes and prompts the user to complete them:
a. User Name;
b. Password;
c. Postal Address;
d. E-mail Address; and
e. Telephone Number.

On receipt of the above data, at step 72, the system 10 requests, at step 74, the user to select an event from a drop down list of events. The system 12 only presents events that are open for people to register.

On receipt of the selection data, at step 76, the system 12 generates and initialises, at step 78, all protocols and databases 16 necessary for the new user. The system 12 saves, at step 80, the relevant information in the database 16 as a new user and generates, at step 82, the administrator's web page for display on the administrator's personal computer 18.

3. Queue-Up.

The system 12 determines each registered user's commitment to purchase tickets to an event by requiring the user to periodically undertake activities before the tickets are available for sale. Each activity is to be completed by the user at a predetermined time on a predetermined day. The system 10 generates a score for each user based on the results of their tasks. That is, how accurately the user fulfilled his or her prescribed tasks, and how often the tasks are undertaken. The user's score is used to determine his or her ranking and, ultimately, when he or she is permitted to purchase tickets to the event.

The Queue Up process performed by the system 12 is hereafter described in the following two stages:
a. Before Queue-Up Window has been Closed; and
b. After Queue-Up Window has been Closed.

a. Before Queue-Up Window has Been Closed

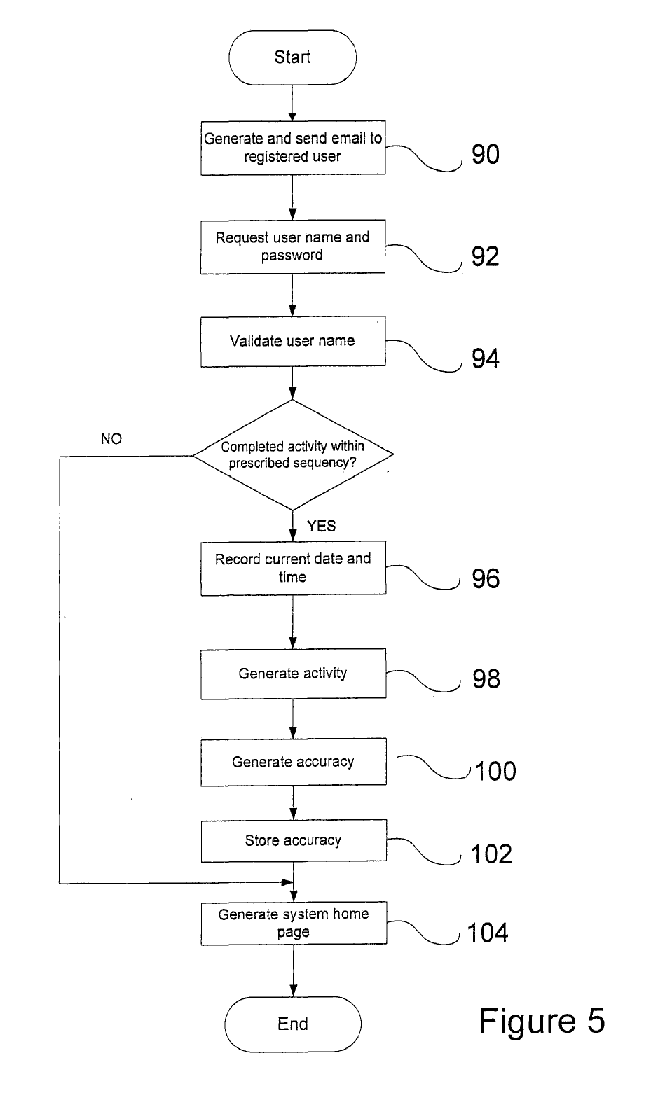

The system 12 performs the steps shown in FIG. 5 to effect the Queue-Up process before the window has been closed. The system 12 periodically invites individual registered user's to complete a predetermined activity. The system 12 invites a registered user to complete an activity by generating and sending, at step 90, an e-mail including instructions to access the system's home page and log on to complete the activity, for example. The instructions include a time and date by which the activity is to be completed. Alternatively, the system 12 sends the user an SMS including the details of the activity to be completed.

A registered user can use his or her personal computer 18 to access the system's home web page (not shown) via the Internet 20. The home page generated by the system 12 includes a “Task” function button. On execution of the “Task” function button, the system 12 requests, at step 92, the user's User name and Password. The system 12 validates these details, at step 94, and determines whether they have previously completed an activity within a frequency prescribed by the system administrator.

If the system 12 validates the details, then the system 12 records, at step 96, the current date and time in the database 16 and generates, at step 98, a display showing the predetermined activity for the user. The predetermined tasks include:
i. A game of Chess;
ii. A game of tic, tac, toe;
iii. A game of noughts and crosses; and
iv. Re-Entering his or her registration details into the system.

The predetermined tasks include any other suitable task that requires the user perform a series of functions.

The accuracy of the task is then generated, at step 100, by the system 12 based on the previous time they completed a task for the event. The system 12 compares each task time with the task time previously generated for the user. The difference between these values is known as the ‘accuracy’ of a task. The accuracy of each task for the user is also stored, at step 102, by the system in the database 16.

The system 12 stores the details of each activity completed in the database 16 and returns the user, at step 104, to the system's home page.

b. After Queue-Up Window has Been Closed

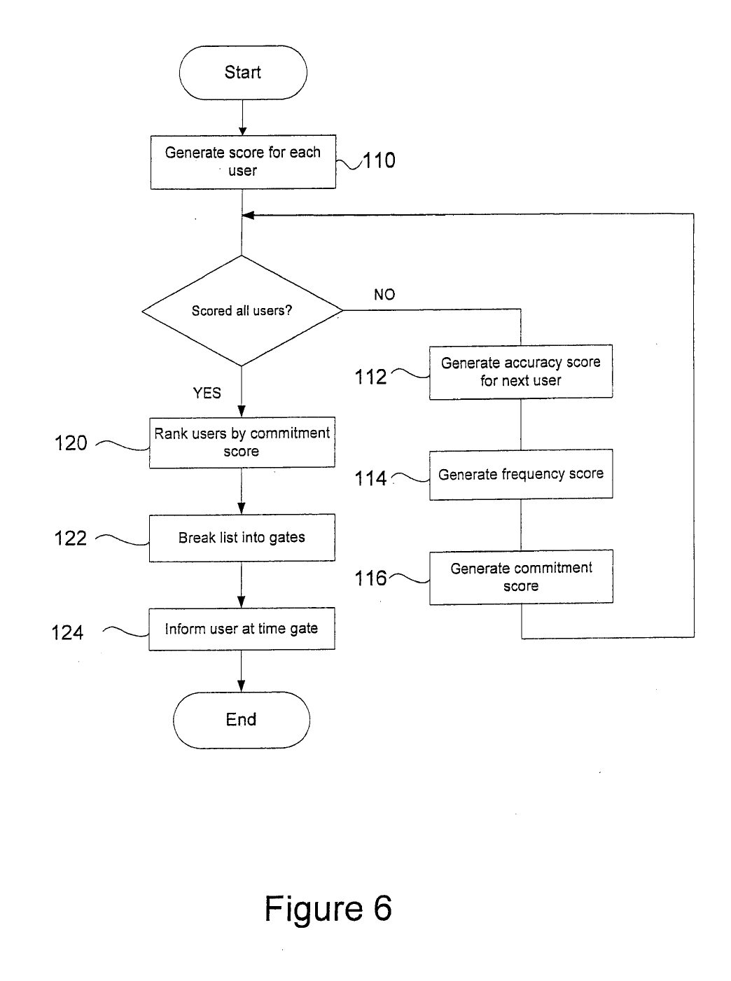

The system performs the steps shown in FIG. 6 after the After the Queue-Up window is closed. The system 12 generates, at step 110, a score for each user registered for the event. The system 12 performs the following steps for each user:
i. All of the task scores are generated, at step 112, to establish a single Accuracy Score;
ii. The user's Frequency Score is then generated, at step 114, based on the number of times the user completed tasks;
iii. The user's Commitment Score is then generated, at step 116, by adding the Frequency Score and the Accuracy Score together.

After generating each user's Commitment Score, the system 12 ranks, at step 118, the users in descending order of Commitment Score.

The data entered into the system 12 during the Set-Up New Event process shown in FIG. 3, pertaining to the number of event openings (gates) and the number of users allowed in each gate is used by the system 12 to break the list of users in the database 16, at step 122, into a discrete number of gates. Each one of these gates is given a start time. The system 12 allocates users with a higher commitment scores gates which open earlier. The system 12 informs, at step 124, the user as to his or her allocated gate number, and the opening time of that gate. This information is sent to the user by e-mail generated by the system 12, or a text message to a mobile device 18 generated and sent by the system.

Users that are not allocated a reserved gate by the system 12 are not guaranteed access to the event to purchase a ticket and are allocated an unreserved gate number.

4. Purchase Item.

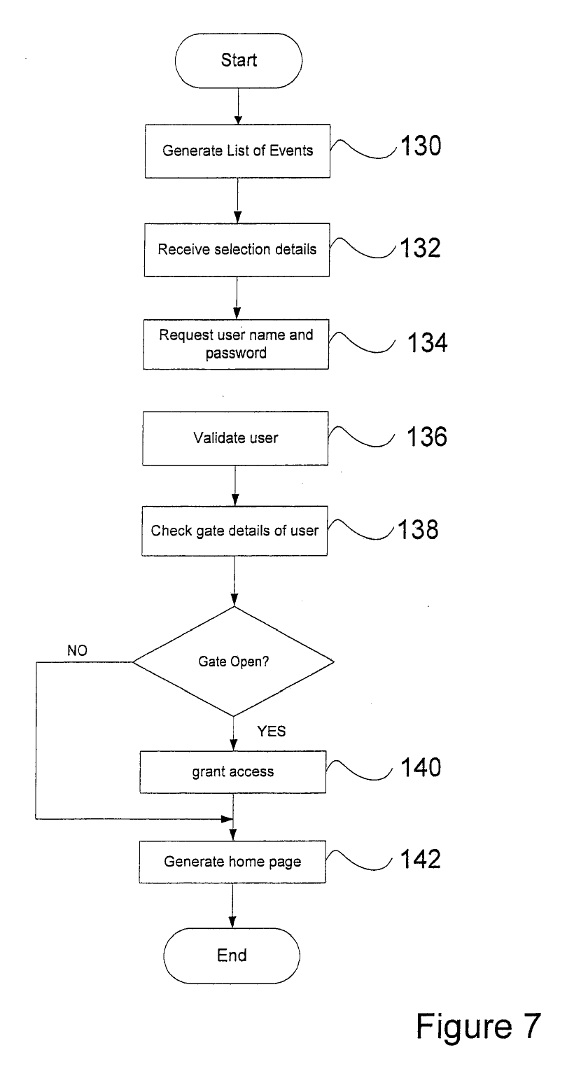

Once the above described gate allocation process has been completed and the event is open for registered users to purchase tickets for the event. A registered user can use his or her personal computers 18 to access the system's home web page (not shown) via the Internet 20 to purchase tickets for the event. The home page generated by the system 12 includes a “Purchase Item” function button that, when executed, generates a form that includes a list of events that are currently open. The system 12 performs the steps shown in FIG. 7 to purchase a ticket for a user.

On execution of the “Purchase Item” function button, the system 12, generates, at step 130, a list of events for the user to select from. The user can select an event from the list. On receipt, at step 132, of the users selection data, the system 12 requests, at step 134, the user to enter his or her user name and password. The system 12 then validates, at step 136, the user and password. The system then checks, at step 138, whether the user has access via a gate to purchase tickets to the concert. If the user is approved, the system grants access, at step 140, to the event and the user can purchase one or more tickets. Processes for making such payments are known in the relevant art and are not described here in further detail.

The system 12 returns, at step 142, the user to the system home page on completion of this process.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

1. A system for managing sale of one or more items, said system performing the steps of:
(a) generating with a processor predetermined activities for potential purchasers of one or more of said items before said items are available for sale;
(b) ranking the potential purchasers in accordance with results of said predetermined activities, information relating to said potential purchasers and said results being stored in a database of said system; and
(c) allocating each potential purchaser of said purchasers a time period within which he or she is permitted to purchase one or more of said items, after the items are made available for sale, in accordance with his or her ranking.

2. The system claimed in claim 1, wherein the step of ranking the potential purchasers is effected in accordance with frequency of said predetermined activities.

3. The system claimed in claim 1, wherein the step of ranking the potential purchasers is effected in accordance with the accuracy of said predetermined activities.

4. The system claimed in claim 1, wherein one of said predetermined activities is submitting an expression of interest to purchase one or more of said items.

5. The system claimed in claim 1, wherein one of said predetermined activities is registration his or her details with the system.

6. The system claimed in claim 5, wherein registration includes the step of submission of the following information:
a. contact details;
b. age; and
c. email address.

7. The system claimed in claim 1, wherein the step of ranking includes the step of grouping potential purchasers into groups.

8. The system claimed in claim 7, wherein the groups are ranked sequentially in accordance with the results of the predetermined activities.

9. The system claimed in claim 7, wherein the step of allocating includes the step of allocating the potential purchasers of each group of said groups a common time period within which they are permitted to purchase one or more of said items after the items are made available for sale.

10. The system claimed in claim 1, including the steps of receiving a request to purchase one or more of said items from one of said potential purchasers after the items are made available for sale; and permitting the sale of one or more of said items if said one of said potential purchasers is attempting to do so within his or her allocated time period.

11. The system claimed in claim 1, including the steps of receiving a request to purchase one or more of said items from one of said potential purchasers after the items are made available for sale; and permitting the sale of one or more of said items if said one of said potential purchasers is attempting to do so within his or her allocated time period or after his or her allocated time period.

12-18. (canceled)

19. A system for managing sale of one or more items, said system for performing the steps of:
(a) generating with a processor predetermined activities for potential purchasers of one or more of said items before said items are available for sale; and
(b) ranking the potential purchasers in accordance with results of said predetermined activities, information relating to said potential purchasers and said results being stored in a database of said system.

20. The system claimed in claim 19, wherein the step of ranking the potential purchasers is effected in accordance with frequency of said predetermined activities.

21. The system claimed in claim 19, wherein the step of ranking the potential purchasers is effected in accordance with the accuracy of said predetermined activities.

22. The system claimed in claim 19, wherein one of said predetermined activities is submitting an expression of interest to purchase one or more of said items.

23. The system claimed in claim 19, wherein one of said predetermined activities is registration his or her details with the system.

24. The system claimed in claim 23, wherein registration includes the step of submission of the following information:
a. contact details;
b. age; and
c. email address.

25-73. (canceled)
